(19) United States
(12) Patent Application Publication
(10) Pub. No.: US 2026/0352367 A1
(43) Pub. Date: Nov. 5, 2026

(54) CHANNEL HOPPING METHODS AND APPARATUS

(71) Applicant: Telefonaktiebolaget LM Ericsson (publ), Stockholm (SE)

(72) Inventors: Sabrine AROUA, ANTONY (FR); Illyyne SAFFAR, LE PLESSIS ROBINSON (FR); Nizar KHEIR, GIF SUR YVETTE (FR)

(73) Assignee: Telefonaktiebolaget LM Ericsson (publ), Stockholm (SE)

(21) Appl. No.: 19/108,059

(22) PCT Filed: Sep. 2, 2022
(86) PCT No.: PCT/IB2022/000658

§ 371 Date: Feb. 28, 2025

(51) Int. Cl. H04K 3/00; H04W 12/122; H04W 72/566

(52) U.S. Cl. CPC H04K 3/224; H04W 12/122; H04W 72/566

(57) ABSTRACT

A method (100), performed by a Radio Access Network (RAN) node in a communication network, is disclosed. The method comprises, on detecting that a first channel, over which the RAN node is exchanging communication signals with a first user node, is subject to a jamming attack (110), identifying, from among channels in the communication network that are not currently occupied by any user node having an assigned priority over a threshold level, the channel that is predicted to have the greatest Time To Rendezvous (TTR) with an entity targeting the first user node with a jamming attack (120). The method further comprises initiating communication with the first user node over the identified channel (130), and causing communication signals on the first channel to emulate the communication signals that were exchanged between the RAN node and the first user node over the first channel (140).

### TECHNICAL FIELD

The present disclosure relates to a method performed by a Radio Access Network (RAN) node in a communication network, and to a method performed by a first user node in a communication network. The present disclosure also relates to a RAN node, a first user node, and to a computer program product configured, when run on a computer, to carry out such methods.

### BACKGROUND

Radio jamming is the act of an illegitimate radio device attempting to disrupt radio communication between a legitimate sender and a legitimate receiver. When they go undetected or unprevented, radio jamming attacks may lead to denial of service on either or both of the impacted user equipment (UE) and the network. Radio jamming attacks are carried out by illicitly occupying the physical medium (i.e., radio channel) that is being used by a legitimate sender. This occupation is achieved by emitting Radio Frequency noise signal, making it impossible for the legitimate receiver to recover the original message emitted by the sender. The shared nature of wireless channels enables a jammer to disable all data transmission within the radio range. The openness and mobility of wireless communication render them vulnerable to various types of jamming attacks, which seriously threaten the users' communication security.

Different strategies exist to ensure the safety and security of the wireless medium. Most existing strategies focus on designing anti-jamming techniques, enabling legitimate users to continue their communication securely. Existing anti-jamming techniques may be classified into two main classes, Rate Adaptation/power control, and channel hopping.

The basic idea of power control and rate adaptation schemes consists of estimating the channel conditions and adjusting the data rate or the power transmission in order to improve communication quality. The jammer's signal is effectively considered as interference, and despite the present threat, legitimate users continue to use the same channel as jammers. When varying, i.e., increasing or decreasing, the data rate or the power control, legitimate users focus on how to override the jamming signal in a way to ensure successful data transmission from emitters to receivers. However, jammers might adopt the same strategy as the legitimate users and adapt their signals to produce higher interference to legal users. Another side effect of these approaches is that rate adaptation and power control are not well adapted to users with energy constraints, as increasing the power transmission will damage and drain their batteries.

The concept of frequency hopping involves switching the carrier frequency between different bands, thereby selecting the best band that improves the quality of service (QoS) and enables better link conditions. Frequency hopping is already used in Bluetooth to enhance its reliability against undesired interfering signals and jamming attacks. In addition, frequency hopping presents the basic concept of cognitive radio networks that guarantee the opportunistic access of secondary users to the licensed bands while not being used by primary, i.e., licensed, users. The channel hopping technique is widely recommended, and in the presence of jammers, when compared with the radio adaptation and power control strategy, frequency hopping has a lower complexity. Legitimate users can escape from jammers and find new channels to improve the reliability of wireless communications. Therefore, channel hopping enables legitimate users to continue the transmission on a new secure channel without interruption.

Different studies introducing new channel hopping schemes for anti-jamming communication exist. In Pei, X., Wang, X., Yao, J., Yao, C., Ge, J., Huang, L., & Liu, D. (2019 October) Joint time-frequency anti-jamming communications: a reinforcement learning approach, 2019 11th International Conference on Wireless Communications and Signal Processing (WCSP) (pp. 1-6) IEEE, the authors design a new solution based on the Markov model and reinforcement learning to find the optimal transmission channel that provides the best duration to continue communication, and the maximum long-term cumulative throughput. The study in Lee, E. K., Oh, S. Y., & Gerla, M. (2010 October), Randomized channel hopping scheme for anti-jamming communication, 2010 IFIP Wireless Days (pp. 1-5) IEEE, introduces a Quorum Rendezvous channel hopping scheme. A sender and a receiver do not explicitly establish an initial essential pairing. Instead, they hop over multiple random channels to transmit data without relying on opportunistic encounters. The hopping sequences are constructed from a quorum system to ensure that the nodes can find their next rendezvous channel within a bounded time limit. In Lee et al., new channel sequences are designed to minimize the Time to Rendezvous (TTR) each time a jamming attack is detected. The TTR is the time, measured in time slots, needed for a successful rendezvous, i.e., Request to Send (RTS)/Clear to Send (CTS) exchange on one channel.

In both the above studies, the authors assume a fixed strategy of the jammer, which means it can't follow the target or reveal the new transmitting channels. To deal with this problem, Pourranjbar, A., Kaddoum, G., Ferdowsi, A., & Saad, W. (2021) Reinforcement learning for deceiving reactive jammers in wireless networks, IEEE Transactions on Communications, 69(6), 3682-3697 introduces a novel anti-jamming strategy based on reinforcement learning to deceive the jammer. According to this strategy, legitimate users determine two channels: a first channel is used to continue the communication, and a second channel is called the victim channel. In this second channel, legitimate users send fake signals to attract the jammers and keep them on this channel, thereby not disturbing legitimate users. The authors of this study determine the optimal power and channel allocation based on the jammers' channel gain to deceive jammers

Existing anti-jamming studies present different limitations. Works on data rate adaptation and power control strategies always assume limited intelligence and power constraints on the part of the jammer. However, jammers are generally now more powerful, and may adapt their power and increase it to introduce higher interference to legitimate users. In addition, this strategy is not adequate for scenarios in which the sender and receiver exchange sensitive information, or data with strict requirements in terms of latency.

Most of the existing studies on channel hopping also assume a fixed strategy on the part of a jammer. The next channel used to continue the communication is selected based only on legitimate users' Quality of Service (QoS) requirements while minimizing the TTR between the sender and receiver. The possibility that jammers could rapidly reveal the next channel selected by legitimate users, and therefore rapidly join this new channel to disturb the communication, is generally neglected.

Those Anti-jamming strategies that do seek to deceive jammers focus on which channel to use to transmit a fake signal that keeps jammers on that channel. Generally, existing studies propose to emit artificial signals or increase the fake power transmitted on the victim channel substantially arbitrarily, while increasing the gain between legitimate users and the jammers. Deceptive anti-jamming solutions such as that proposed by Pourranjbar et al. assume a threat model in which the attacker does not know any characteristics or properties of the legitimate signal to be intercepted. The focus for these solutions is to identify the channels which are more likely to be targeted by an attacker, and to transmit decoy signals over those channels. Jammers are deceived into attacking these channels, leaving other channels available for communication. While this threat model can be reasonably applied to mobile broadband users, it is much less appropriate for Mission Critical networks that sustain machine type communications. Unlike human users, machine-type communications are highly predictable for an attacker, making it much easier for an attacker to detect in near real-time the channel that is used to carry the legitimate communication, and to orient jamming attacks towards this channel.

A common limitation that applies to all existing studies based on deceiving jammers and channel hopping is that they consider the jammer tool to act statically, i.e., the jammer selects the target channel and keeps attacking the same channel until the attacker chooses to hop to another one. While this may not be problematic in Mobile Broadband applications (MBB), it is much more concerning in mission-critical applications, especially for Ultra-Reliable Low Latency Communications (URLLC) as described in 3GPP. In such cases, the message format targeted by the attack is likely to be known by the attacker. The attacker may then track this signal throughout the channel hopping process, leading to a long-lasting denial of service.

### SUMMARY

It is an aim of the present disclosure to provide methods, a RAN node, a first user node, and a computer program product which at least partially address one or more of the challenges mentioned above. It is a further aim of the present disclosure to provide methods, a RAN node and a first user node which cooperate to facilitate robust channel hopping to protect communications from jamming attacks.

According to a first aspect of the present disclosure, there is provided a method performed by a Radio Access Network (RAN) node in a communication network. The method comprises, on detecting that a first channel, over which the RAN node is exchanging communication signals with a first user node, is subject to a jamming attack, identifying, from among channels in the communication network that are not currently occupied by any user node having an assigned priority over a threshold level, the channel that is predicted to have the greatest Time To Rendezvous (TTR) with an entity targeting the first user node with a jamming attack. The method further comprises initiating communication with the first user node over the identified channel, and causing communication signals on the first channel to emulate the communication signals that were exchanged between the RAN node and the first user node over the first channel.

According to another aspect of the present disclosure, there is provided a method performed by a first user node in a communication network. The method comprises, on detecting that a first channel, over which the first user node is exchanging communication signals with a RAN node, is subject to a jamming attack, communicating with the RAN node over an identified channel, wherein the identified channel has been identified, from among channels in the communication network that are not currently occupied by any user node having an assigned priority over a threshold level, as being predicted to have the greatest TTR with an entity targeting the first user node with a jamming attack. According to the method, communication signals on the first channel are caused to emulate the communication signals that were exchanged between the RAN node and the first user node over the first channel.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node in a communication network. The RAN node comprises processing circuitry configured to cause the RAN node to, on detecting that a first channel, over which the RAN node is exchanging communication signals with a first user node, is subject to a jamming attack, identify, from among channels in the communication network that are not currently occupied by any user node having an assigned priority over a threshold level, the channel that is predicted to have the greatest TTR with an entity targeting the first user node with a jamming attack. The processing circuitry is further configured to cause the RAN node to initiate communication with the first user node over the identified channel, and to cause communication signals on the first channel to emulate the communication signals that were exchanged between the RAN node and the first user node over the first channel.

According to another aspect of the present disclosure, there is provided a first user node in a communication network. The first user node comprises processing circuitry configured to cause the first user node to, on detecting that a first channel, over which the first user node is exchanging communication signals with a RAN node, is subject to a jamming attack, communicate with the RAN node over an identified channel, wherein the identified channel has been identified, from among channels in the communication network that are not currently occupied by any user node having an assigned priority over a threshold level, as being predicted to have the greatest TTR with an entity targeting the first user node with a jamming attack. Communication signals on the first channel are caused to emulate the communication signals that were exchanged between the RAN node and the first user node over the first channel.

Aspects of the present disclosure thus provide methods and nodes that implement a channel hopping process to maximize the TTR between a jammer and legitimate users, taking account of jammer intelligence in identifying a target signal. In this manner, data can be transmitted by the legitimate users while preserving reliability and latency requirements. Causing communication signals on the first channel to emulate the communication signals that were exchanged between the RAN node and the first user node over the first channel ensures that for a jammer, discovering that the signal transmitted on the first communication channel not in fact the target signal is a highly challenging task. Jammers are therefore encouraged to remain on the originally targeted channel, allowing legitimate users to change frequency band and continue their communication on a new secure channel.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method performed by a RAN node;

FIGS. 2a to 2f show flow charts illustrating another example of a method performed by a RAN node;

FIG. 3 is a flow chart illustrating process steps in a method performed by a first user node;

FIGS. 4a and 4b show flow charts illustrating another example of a method performed by a first user node;

FIG. 5 is a block diagram illustrating functional modules in an example RAN node;

FIG. 6 is a block diagram illustrating functional modules in another example RAN node;

FIG. 7 is a block diagram illustrating functional modules in an example first user node;

FIG. 8 is a block diagram illustrating functional modules in another example first user node;

FIG. 9 illustrates a part of a cellular communication network deployed for a specific mission-critical system;

FIG. 10 is a flow chart illustrating a process flow that may be used to implement examples of the method;

FIGS. 11 and 12 are sequence diagrams showing messages exchanges and processing steps carried out in order to implement the process flow of FIG. 10;

FIG. 13 illustrates a Reinforcement Learning process for channel selection;

FIG. 14 illustrates signal to signal translation;

FIG. 15 illustrates a neural network architecture for signal to signal translation; and

FIG. 16 illustrates data and control channels.

### DETAILED DESCRIPTION

Anti-jamming strategies based on channel hopping are very efficient in avoiding jammers and rapidly continuing communication on a secure channel. However, as discussed above, the existing studies present many limitations, especially for mission-critical networks where sensitive and URLLC data are usually present. Example methods according to the present disclosure take into account a jammer's capacity to track legitimate users as they switch to other channels, as well as a jammer's ability to identify, over the radio interface, the relevant transmitted signals to be jammed, while also discarding other forms of decoy signals, such as simple fakes or imitations as proposed in Pourranjbar et al.

Examples of the present disclosure propose an approach that combines channel hopping with jamming deception. A sender and receiver agree on a new channel to avoid jamming while at the same time deceiving the jammer so that the attacker believes the sender and receiver are still using the old channel. This is made possible, according to examples of the present disclosure, by continuing to occupy the old channel to deceive the jammer, while at the same time hopping to a new radio channel for communication.

Example methods according to the present disclosure consider both how to select a new secure channel, and how to deceive jammers having a degree of intelligence. A new channel allocation-based reinforcement learning solution is presented that selects a next channel that maximizes the Time to Rendezvous (TTR) between jammers and legitimate users. Unlike existing studies that focus on how to minimize TTR between the legitimate sender and receiver, examples of the present disclosure focus on maximizing TTR between the jammer and the legitimate users, taking account of jammer intelligence in identifying and following a target signal. In this manner, the duration of secure and high-quality communication between legitimate users is also maximized. Also presented is a solution to the problem of how to deceive smart jammers so that a jammer with good knowledge about legitimate users' communication can see no behavior changes. The present disclosure introduces a Machine Learning (ML) solution proposing that a sender adapts its RF signal such that it emulates the original transmitted signal on a target channel. Concurrently with this signal emulation, legitimate users switch to the newly selected channel to proceed with sending the legitimate signal. It will be appreciated that this signal emulation process is different to other deceptive approaches such as that of Pourranjbar et al., not least because the decoy signal is not set randomly. Rather, it is determined based on the legitimate signal to be protected, in such a way that both the decoy and legitimate signals would look substantially identical from the perspective of an external radio jammer.

While the methods and nodes described herein are applicable to both MBB and URLLC, they are particularly relevant to URLLC including mission-critical applications such as smart grids, public safety, and transportation. Mission-critical networks are very attractive to jammers as they carry sensitive communications. Generally, in mission-critical applications, devices may have different priorities in transmitting data. For example, in smart grids, some devices might have critical data that should be transferred to the network with high reliability. Other data may be less sensitive. For example, smart meters periodically send data about users' energy consumption in this context. These measurements can be recovered through other subsequent messages. However, data like outages or emergency notifications are much more sensitive and should be reliably transmitted to the network with low latency. Examples of the present disclosure leverage this property as part of the deception strategy, so that the jammer can no longer reliably identify sensitive communications out of many other non-sensitive communications present on the air interface

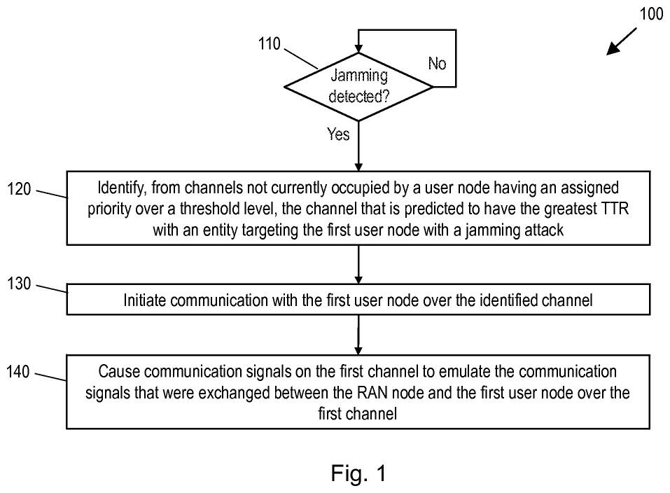

FIG. 1 is a flow chart illustrating process steps in a method 100 performed by a Radio Access Network (RAN) node in a communication network. A RAN node of a communication network comprises a node that is operable to transmit, receive, process and/or orchestrate wireless signals. A RAN node may comprise a physical node and/or a virtualised network function, and may comprise multiple logical entities, any one or more of which may be running in a cloud, edge cloud or fog deployment. The RAN node may for example be part of a cloud-based deployment. In some examples, a RAN node may comprise a NodeB, eNodeB, gNodeB, etc., or any other current or future implementation of such functionality.

Referring to FIG. 1, the method 100 comprises, on detecting in step 110 that a first channel, over which the RAN node is exchanging communication signals with a first user node, is subject to a jamming attack, performing step 120. Step 120 comprises identifying, from among channels in the communication network that are not currently occupied by any user node having an assigned priority over a threshold level, the channel that is predicted to have the greatest Time To Rendezvous (TTR) with an entity targeting the first user node with a jamming attack. The method then comprises initiating communication with the first user node over the identified channel in step 130, and causing communication signals on the first channel to emulate the communication signals that were exchanged between the RAN node and the first user node over the first channel in step 140.

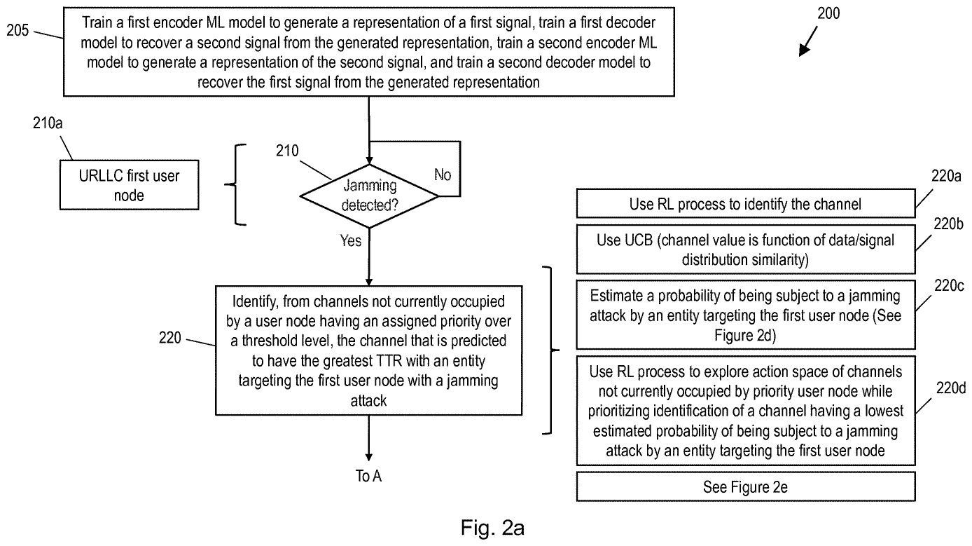

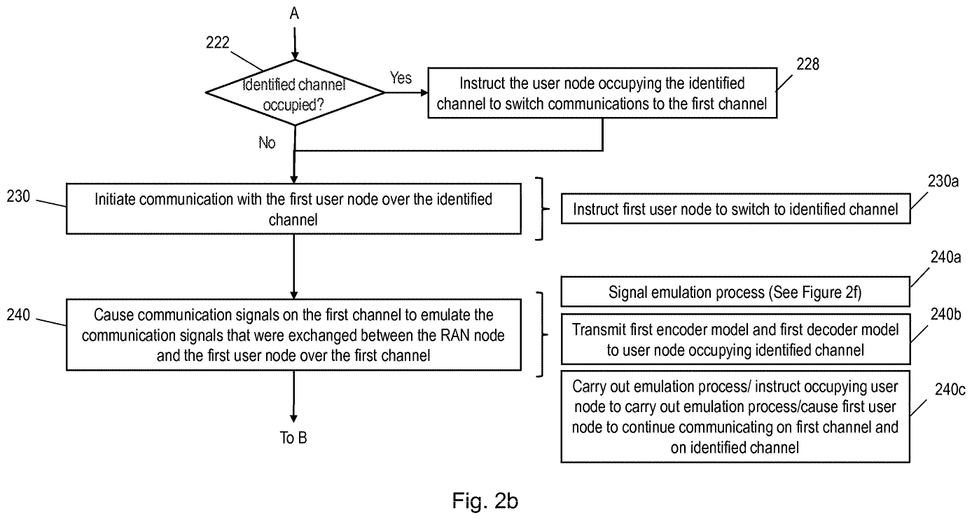

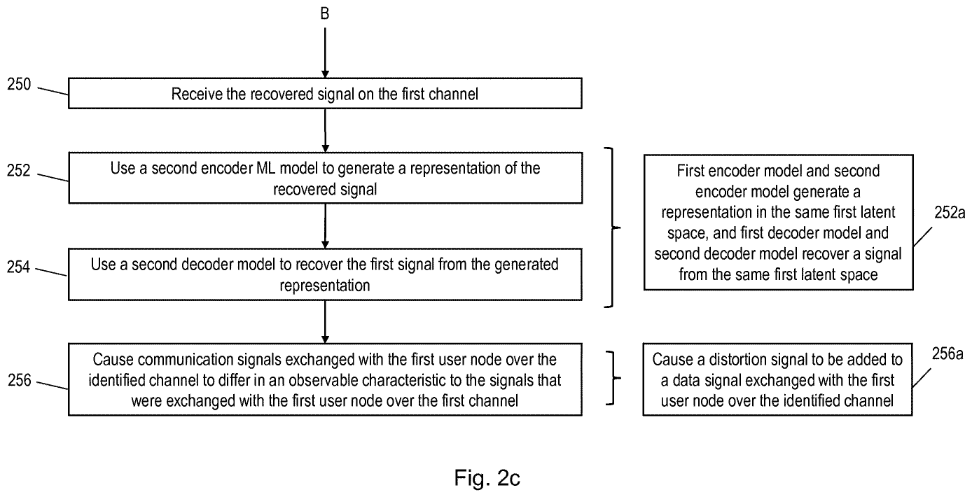

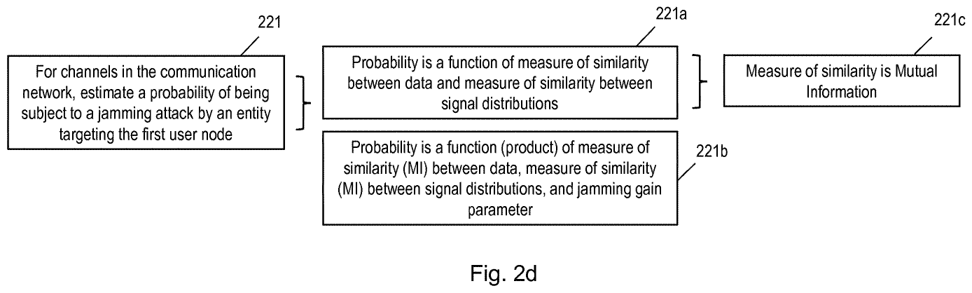

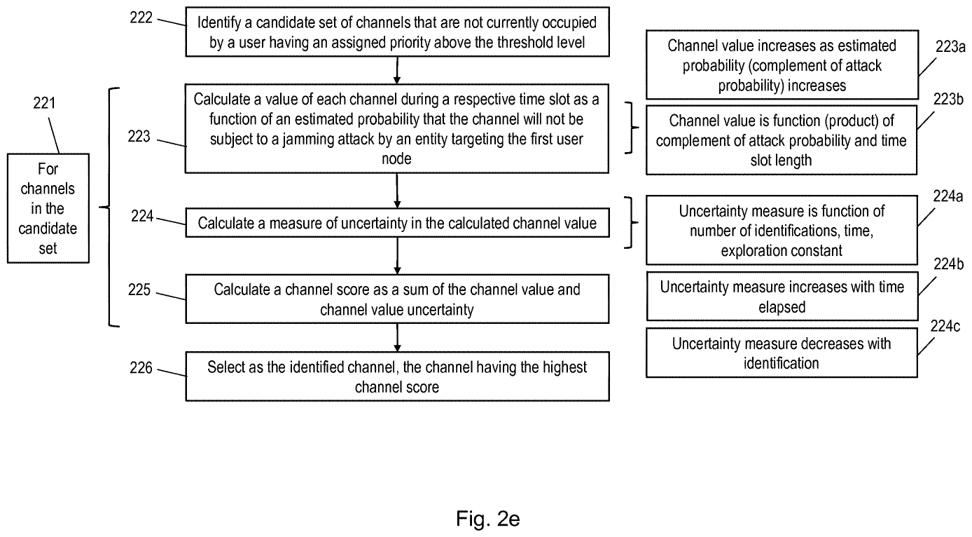

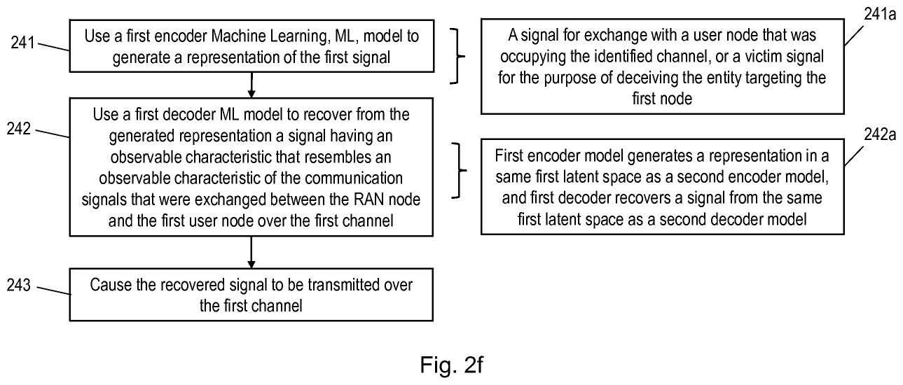

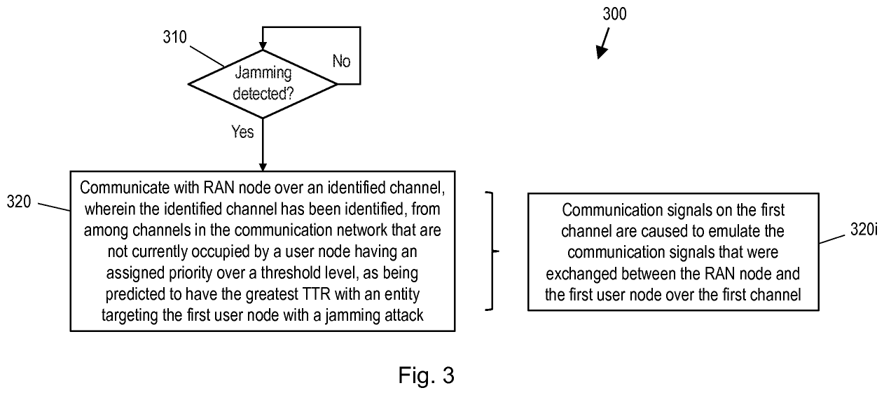

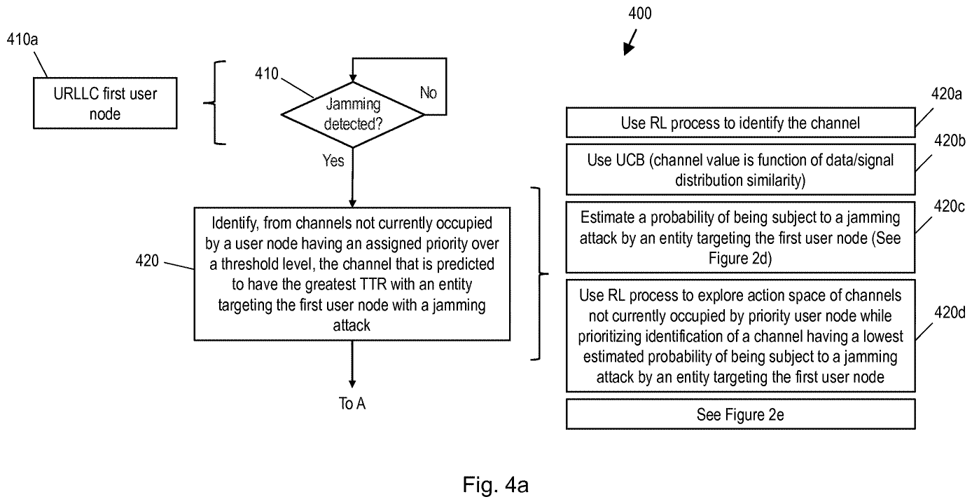

The method 100 thus performs channel selection to maximize TTR with a jamming entity, and uses signal emulation on the original channel to deceive the jammer into remaining on that channel. As discussed above, TTR is the amount of time (measured for example in time slots or in seconds) within which two users can switch to a common channel (i.e. experiencing a rendezvous) at an overlapping period of time (overlapping slot). The idea of maximizing TTR offers the advantage of taking account of jammer intelligence in recognizing target signals, while emulation seeks to keep the jammer focused on the original channel. Emulation is the process of mimicking outwardly observable behavior to match an existing target. Signal emulation thus seeks to adapt a radio signal such that its outwardly observable characteristics resemble a target signal, such that the emulation signal may be used to substitute, in terms of outwardly observable behavior, for the target signal. The signal emulation could be performed by the RAN node, the first user node (for example in dual mode user plane) or by a non prioritized user that was occupying the identified channel and switches to the original channel. Each of these options is discussed in greater detail below, with reference to FIGS. 2a to 2e, 3 and 4a to 4b.

The method 100 uses assigned priority of user nodes to filter those channels in the communication network which may be identified in step 120. The priority may be assigned by any suitable entity, and the threshold may be set by any suitable entity. For example, the threshold may be set such that URLLC users have a priority above the threshold, and all other users have a priority below the threshold. The precise values of priority and threshold will depend on the given deployment scenario, but they have the effect of insulating users having a priority above the threshold, such that any channels currently occupied by such users are not considered from channel hopping, and so will not be caused to change channel or otherwise disturbed by the present method.

FIGS. 2a to 2e show flow charts illustrating another example of a method 200 performed by a RAN node in a communication network. A RAN node may comprise for example a NodeB, eNodeB, gNodeB, etc. as discussed above with reference to the method 100. The method 200 illustrates examples of how the steps of the method 100 may be implemented and supplemented to provide the above discussed and additional functionality.

Referring initially to FIG. 2a, in a first step 205, the RAN node trains a first encoder Machine Learning (ML) model to generate a representation of a first signal, and trains a first decoder ML model to recover a second signal from the generated representation. The RAN node also trains a second encoder ML model to generate a representation of the second signal, and trains a second decoder ML model to recover the first signal from the generated representation. In step 205, the first and second encoder ML models, and first and second decoder ML models, are all trained at the same time with the same shared first latent space, and may in some examples be considered as a single ML model comprising two encoders, two decoders, and a single shared latent space. The first signal may be the first signal for a subsequent emulation process as discussed below, i.e., the signal of a non-prioritized user occupying an identified channel, or a victim signal whose sole purpose is to resemble the signals exchanged with the targeted first user node. The second signal may be a signal resembling that exchanged with a targeted first user node. This training step may therefore be carried out preemptively in anticipation of targeting of a first user node, or following detection of a jamming attack on a first user node. In some examples, the method 200 may further comprise a step of performing online updating of the ML model comprising the two encoders, two decoders and shared latent space, the updating triggered for example in the event of signal drift between training time and inference time.

For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

In step 210, the RAN node checks for detection of a jamming attack. Many solutions exist for the detection of a jamming attack over the air interface, three examples of which are discussed below. In Muraleedharan, Rajani, and Lisa Ann Osadciw. “Jamming attack detection and countermeasures in wireless sensor network using ant system.” Wireless Sensing and Processing. Vol. 6248. SPIE, 2006, the authors propose a novel solution to predict the presence of jammer attacks on sensor nodes using receiver operating characteristics (ROC). This solution achieves maximum reliability and improves the quality of service of wireless sensor networks. In Thamilarasu, Geethapriya, Sumita Mishra, and Ramalingam Sridhar. “Improving reliability of jamming attack detection in ad hoc networks.” International Journal of Communication Networks and Information Security 3.1 (2011): 57, the authors propose a solution to differentiate between jamming and congested network scenarios using a piece of cross-layer information. By correlating the cross-layer data with collision detection metrics, it is possible to distinguish attack scenarios from the impact of traffic load on network behavior, thereby accurately detecting the presence of a jammer. In Yang, Hongjiu, et al. “Security research on wireless networked control systems subject to jamming attacks.” IEEE transactions on cybernetics 49.6 (2018): 2022-2031, the authors develop a time series model in which they measure the state of the link over a series of times and compared it with the past link data to detect the state of the communication link.

On detecting that a first channel, over which the RAN node is exchanging communication signals with a first user node, is subject to a jamming attack, the RAN node proceeds to step 220. In some examples, the first user node may comprise an Ultra-Reliable Low-Latency Communication, URLLC, user node, as illustrated at 210a. In further examples, the first user node may have an assigned priority above a threshold level. In other examples (not shown), if the first user node does not have a priority above a threshold level, or is not an URLLC node, the RAN node may abort the method 100, such that subsequent steps are only performed if the first user node has a sufficiently high assigned priority, is an URLLC node.

In step 220, the RAN node identifies, from among channels in the communication network that are not currently occupied by any user node having an assigned priority over a threshold level, the channel that is predicted to have the greatest TTR with an entity targeting the first user node with a jamming attack. As illustrated at 220a, this may comprise using a Reinforcement Learning (RL) process to identify the channel. In some examples, as illustrated at 220b, identifying a channel in step 220 may comprise using the Upper Confidence Bound (UCB) algorithm to identify the channel, wherein channel value for the UCB algorithm comprises a function of similarity between at least one of:
data exchanged between the RAN node and the first user node, and data exchanged between the RAN node and a user node occupying the channel; and
signal distributions of the data exchanged between the RAN node and the first user node, and the data exchanged between the RAN node and a user node occupying the channel.

Similarity between data and/or signal distributions may be indicative of a likelihood for the channel to be attacked by a jammer targeting the first user node, thus allowing to identify a channel that maximizes TTR with the jammer. As illustrated at 220c, identifying the channel that is predicted to have the greatest TTR with an entity targeting the first user node with a jamming attack may comprise, for channels in the communication network, estimating a probability of being subject to a jamming attack by an entity targeting the first user node. It will be appreciated that a conceptual connecting exists between the TTR with a jammer on any given channel and the probability of that channel being subject to jamming attack. Examples of the method 200 seek to estimate the probability because the jammer entity is unknown, so the actual probability distribution for attack on any given channel is unknown. Examples of the present disclosure propose to estimate this probability based on similarity of data and/or signal distributions (and not just channel gain). In this manner, the intelligence of a jammer seeking to target a specific user node, and which may have some knowledge of the target signal, can be used to more accurately estimate the probability that the jammer will attack a given channel.

Steps that may be performed in order to carry out the estimation of probability at step 220c are illustrated in FIG. 2d.

Referring now to FIG. 2d, for channels in the communication network, estimating a probability of a channel being subject to a jamming attack by an entity targeting the first user node at step 241 may comprise calculating the estimated probability as a function of:
a similarity measure between data exchanged between the RAN node and the first user node, and data exchanged between the RAN node and a user node occupying the channel; and
a similarity measure between the signal distributions of the data exchanged between the RAN node and the first user node, and the data exchanged between the RAN node and a user node occupying the channel.

Examples of the present disclosure thus propose that the probability of a channel being jammed is dependent on similarity of a signal on the channel to the target signal. This concept is particularly relevant in URLLC, in which the data and signal distribution of a target may be estimated by the jammer. Calculating probability in this way thus takes account of jammer intelligence to improve the estimation of probability that any given channel will be subject to a jamming attack by a jammer targeting a specific user node.

In some examples, as illustrated in 221c, the similarity measure comprises Mutual Information (MI). The concept of Mutual Information is well established in Probability and Information theory. Mutual information (MI) of two random variables is a measure of the mutual dependence between the two variables. More specifically, it quantifies the “amount of information” obtained about one random variable by observing the other random variable. For a pair of random variables X and Y, MI determines how different the joint distribution of the pair (X,Y) is from the product of the marginal distributions of X and Y.

As illustrated at 221b, in some examples, estimating a probability of a channel being subject to a jamming attack by an entity targeting the first user node comprises calculating the estimated probability as a function also of a jamming gain parameter for the channel. The jamming gain parameter for the channel is a function of:
the channel gain between the user node occupying the channel and the jamming entity in the channel; and
the power transmission on the channel by the user node occupying the channel.

Also as illustrated at 221b, the function may be a product, such that in some examples, estimating a probability of a channel being subject to a jamming attack by an entity targeting the first user node comprises calculating the estimated probability as the product of:
the MI between data exchanged between the RAN node and the first user node, and data exchanged between the RAN node and a user node occupying the channel;
the MI between the signal distributions of the data exchanged between the RAN node and the first user node, and the data exchanged between the RAN node and a user node occupying the channel; and
a jamming gain parameter for the channel, wherein the jamming gain parameter for the channel is a function of:
   the channel gain between the user node occupying the channel and the jamming entity in the channel; and
   the power transmission on the channel by the user node occupying the channel.

Referring again to FIG. 2a, in some examples, identifying, from among channels in the communication network that are not currently occupied by any user node having an assigned priority over a threshold level, the channel that is predicted to have the greatest TTR with an entity targeting the first user node with a jamming attack may comprise using an RL process to explore an action space of channels in the communication network that are not currently occupied by any user node having an assigned priority over a threshold level while prioritizing identification of a channel having a lowest estimated probability of being subject to a jamming attack by an entity targeting the first user node. The RL process may thus balance exploration of the action space of available channels with exploiting knowledge based on the estimated probabilities.

Steps that may be performed in order to carry out the identification of a channel at step 220 are illustrated in FIG. 2e.

Referring now to FIG. 2e, the RAN node may initially identify, in step 222, a candidate set of channels that are not currently occupied by any user having an assigned priority above the threshold level. The RAN node may then perform steps 223 to 225 for channels in the candidate set.

In step 223, the RAN node calculates a value of each channel during a respective time slot as a function of an estimated probability that the channel will not be subject to a jamming attack by an entity targeting the first user node. As illustrated at 223a, the value of a channel increases as the estimated probability that it will not be subject to a jamming attack by an entity targeting the first user node increases. The probability that the channel will not be subject to a jamming attack by an entity targeting the first user node comprises the complement of the probability that the channel will be subject to a jamming attack by an entity targeting the first user node. It will be appreciated that the complement of a probability is obtained by subtracting the probability from 1. The RAN node may consequently estimate the probability that the channel will be subject to a jamming attack, for example by carrying out the steps discussed above, particularly with reference to FIG. 2d, and may then obtain an estimate of the probability that the channel will not be subject to a jamming attack by subtracting the previously estimate probability from 1.

As illustrated at 223b, the value of each channel during a respective time slot may be calculated by the RAN node as a function of the complement of an estimated probability that the channel will be subject to a jamming attack by an entity targeting the first user node (estimated as discussed above), and the length of the respective time slot. The function may for example be a product.

In step 224, the RAN node calculates a measure of uncertainty in the calculated channel value from step 223. As illustrated at 224a, the measure of uncertainty in the calculated channel value may comprise a function of:
a number of times the respective channel has been identified as the channel that is predicted to have the greatest TTR with an entity targeting the first user node with a jamming attack;
a measure of time elapsed; and
an exploration constant.

The time elapsed may be measured from the time at which the process is triggered by detection of a jamming attack. That is, if jammer is detected during time slot t′ (the period starting at instant t′), then the time elapsed t will begin on the following slot, which is t′+1. The exploration constant is a hyperparameter that can be used to control the degree of exploration of the action space represented by the available channels. This constant may be set by a network operator or administrator, and may control the balance between exploiting estimated probabilities and exploring channels that have not previously been identified.

As illustrated at 224b, the measure of uncertainty in the calculated channel value may increase with increasing time elapsed. As illustrated at 224c, the measure of uncertainty in the calculated channel value may decrease with increasing number of times that a channel has been identified as the channel that is predicted to have the greatest TTR with an entity targeting the first user node with a jamming attack.

In step 225, the RAN node calculates a channel score as a sum of the channel value and channel value uncertainty.

Having completed steps 223 to 225 to channels in the candidate set of step 222, the RAN node then selects as the identified channel, the channel having the highest channel score. It will be appreciated that in some examples, the RAN node may execute steps 222 to 226 by executing the UCB algorithm, with each action of the action space being an available channel (i.e., a channel not occupied by any user with a priority over the threshold value), and channel value defined as set out above.

Having identified a channel in step 220, as illustrated in FIG. 2a, the RAN node then proceeds to check whether or not the identified channel is occupied, in step 222 illustrated in FIG. 2b. If the identified channel is occupied, the RAN node instructs the user node occupying the identified channel to switch communications to the first channel in step 228. The RAN node then initiates communication with the first user node over the identified channel in step 230. As illustrated at 230a, this may comprise instructing the first user node to switch communications to the identified channel. In some examples, initiating communication may further comprise informing the first user node of the identified channel, which may be in addition to (for example in the same message), or as an alternative to instructing the first user node to switch channels. This may be appropriate for example if the first user node does not itself identify the channel. In other examples, (as discussed below), the first user node may concurrently identify the channel, using substantially the same process as the RAN node.

In step 240, the RAN node causes communication signals on the first channel to emulate the communication signals that were exchanged between the RAN node and the first user node over the first channel. As illustrated at 240a, this may comprise causing a signal emulation process to be carried out on a first signal for exchange over the first channel, wherein the signal emulation process causes an observable characteristic of the first signal to resemble an observable characteristic of the communication signals that were exchanged between the RAN node and the first user node over the first channel.

Steps that may be performed in order to carry out the signal emulation process of step 240a are illustrated in FIG. 2f.

Referring now to FIG. 2f, the signal emulation process may initially comprise using a first encoder ML model to generate a representation of the first signal at step 241. This may be the first encoder ML model that was trained in step 205 (i.e., the first encoder part if the encoders, decoders and shared latent space are considered as a single ML model). As illustrated at 241a, the first signal comprises at least one of a signal for exchange with a user node that was occupying the identified channel, or a victim signal for the purpose of deceiving the entity targeting the first node. In this second option, the content of the victim signal is irrelevant, the victim signal is transmitted by the RAN node for the sole purpose of deceiving the jammer. This may be the case when the identified channel was unoccupied.

Following encoding in step 241, the signal emulation process then comprises using a first decoder ML model in step 242 to recover from the generated representation a signal having an observable characteristic that resembles an observable characteristic of the communication signals that were exchanged between the RAN node and the first user node over the first channel. This may be the first decoder ML model that was trained in step 205 (i.e., the first decoder part if the encoders, decoders, and shared latent space are considered as a single ML model). As illustrated at 242a, the first encoder ML model and second encoder ML model are each configured to generate a representation in the same first latent space, and the first decoder ML model and second decoder ML model are each configured to recover a signal from that same first latent space. Thus, all the models share the same first latent space: a latent space to which a pair of corresponding signals in different domains can be mapped, and that enables this transition between the first signal and recovered signal, and then back again.

Causing communication signals on the first channel to emulate the communication signals that were exchanged between the RAN node and the first user node over the first channel then comprises causing the recovered signal to be transmitted over the first channel in step 243.

Referring again to FIG. 2b, causing communication signals on the first channel to emulate the communication signals that were exchanged between the RAN node and the first user node over the first channel may further comprise, in step 240b, transmitting the first encoder ML model and the first decoder ML model to a user node that was occupying the identified channel.

As illustrated at 240c, causing communication signals on the first channel to emulate the communication signals that were exchanged between the RAN node and the first user node over the first channel may comprise at least one of:
carrying out a signal emulation process at the RAN node (as set out in FIG. 2f);
instructing a user node occupying the identified channel to carry out a signal emulation process; or
causing the first user node to continue communicating with the RAN node over the first communication channel, while also initiating communication with the first user node over the identified channel. The first user node may for example use dual mode user plane in order to both communicate with the RAN node over the identified channel and continue to communicate with the RAN node over the first communication channel.

Referring now to FIG. 2c, if the identified channel was occupied, and therefore the first signal in the emulation process was a signal for exchange with a user node that was occupying the identified channel, the RAN node may receive the recovered signal on the first channel in step 250, using a second encoder ML model to generate a representation of the recovered signal in step 252, and using a second decoder ML model to recover the first signal from the generated representation in step 254. As discussed above, the first and second encoder ML models, and first and second decoder ML models rely on a shared latent space assumption, that is an assumption that a pair of corresponding signals in different domains can be mapped to a same latent representation in a shared-latent space. The first encoder ML model and second encoder ML model are therefore each configured to generate a representation in the same first latent space, and the first decoder ML model and second decoder ML model are each configured to recover a signal from the same first latent space, as illustrated at 252a.

In step 256, the RAN node may cause communication signals exchanged with the first user node over the identified channel to differ in an observable characteristic to the signals that were exchanged with the first user node over the first channel. As illustrated at 256a, this may comprise causing a distortion signal to be added to a data signal exchanged with the first user node over the identified channel, wherein an observable characteristic of the combination of the data signal and distortion signal differs from an observable characteristic of the data signal exchanged with the first user node over the first channel. Causing communication signals exchanged with the first user node over the identified channel to differ in an observable characteristic to the signals that were exchanged with the first user node over the first channel may assist with deceiving the jammer, by ensuring that a signal resembling that targeted by the jammer does not appear on another channel shortly after the jamming attack is detected.

The methods 100 and/or 200 described above may be complemented by methods 300 and/or 400 performed by a first user node.

FIG. 3 is a flow chart illustrating process steps in a method performed by a first user node in a communication network. The first user node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. The first user node may for example comprise a User Equipment, terminal device, Machine Type Communication (MTC) device, etc.

Referring to FIG. 3, the method 300 comprises, on detecting that a first channel, over which the first user node is exchanging communication signals with a RAN node, is subject to a jamming attack in step 310, communicating with the RAN node over an identified channel, wherein the identified channel has been identified, from among channels in the communication network that are not currently occupied by any user node having an assigned priority over a threshold level, as being predicted to have the greatest TTR with an entity targeting the first user node with a jamming attack. As illustrated at 320i, communication signals on the first channel are caused to emulate the communication signals that were exchanged between the RAN node and the first user node over the first channel.

The first user node may receive from the RAN node an indication of the identified channel and an instruction to switch to the identified channel. In other examples, the first user node may identify the channel to switch to, as discussed below.

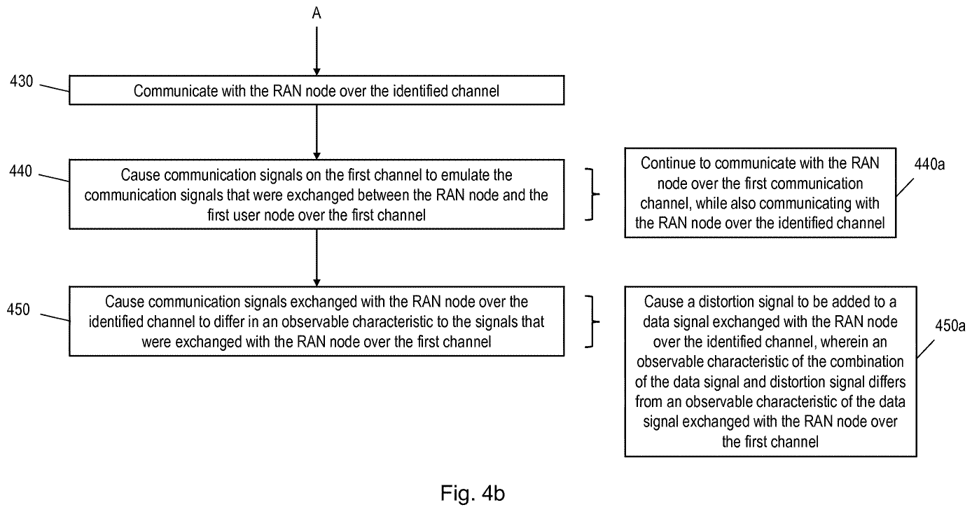

FIGS. 4a and 4b show flow charts illustrating another example of a method 400 performed by a first user node. The first user node may comprise a physical or virtual node, and may for example comprise a User Equipment, terminal device, Machine Type Communication (MTC) device, etc., as discussed above with reference to the method 300. As illustrated at 410a of the method 400, the first user node may comprise an Ultra-Reliable Low-Latency Communication (URLLC) user node. The method 400 illustrates examples of how the steps of the method 300 may be implemented and supplemented to provide the above discussed and additional functionality.

Referring initially to FIG. 4a, in step 410, the first user node checks whether a jamming attack has been detected on a first channel over which the first user node is exchanging communication signals with a RAN node. This detection may be performed in any suitable manner, for example as discussed above with reference to the method 200 performed by the RAN node. On detecting that the first channel, over which the first user node is exchanging communication signals with a RAN node, is subject to a jamming attack, the first user node may then, in step 420, identify, from among channels in the communication network that are not currently occupied by any user node having an assigned priority over a threshold level, the channel that is predicted to have the greatest TTR with an entity targeting the first user node with a jamming attack. As illustrated at 420a, this may comprise using a Reinforcement Learning (RL) process to identify the channel. In some examples, as illustrated at 420b, identifying a channel in step 420 may comprise using the Upper Confidence Bound (UCB) algorithm to identify the channel, wherein channel value for the UCB algorithm comprises a function of similarity between at least one of:
data exchanged between the RAN node and the first user node, and data exchanged between the RAN node and a user node occupying the channel; and
signal distributions of the data exchanged between the RAN node and the first user node, and the data exchanged between the RAN node and a user node occupying the channel.

Similarity between data and/or signal distributions may be indicative of a likelihood for the channel to be attacked by a jammer targeting the first user node, thus allowing to identify a channel that maximizes TTR with the jammer. As illustrated at 420c, identifying the channel that is predicted to have the greatest TTR with an entity targeting the first user node with a jamming attack may comprise, for channels in the communication network, estimating a probability of being subject to a jamming attack by an entity targeting the first user node.

Steps that may be performed in order to carry out the estimation of probability at step 420c are illustrated in FIG. 2d. While FIG. 2d shows steps of the method 200, and the accompanying discussion is presented in the context of those steps being performed by the RAN node, exactly the same steps may be included in the method 400, and performed by the first user node. Reference is therefore made to the description of FIG. 2d for steps that may be carried out by the first user node in estimating the probability of channels being subject to a jamming attack by an entity targeting the first user node.

Referring again to FIG. 4a, in some examples, identifying, from among channels in the communication network that are not currently occupied by any user node having an assigned priority over a threshold level, the channel that is predicted to have the greatest TTR with an entity targeting the first user node with a jamming attack may comprise using an RL process to explore an action space of channels in the communication network that are not currently occupied by any user node having an assigned priority over a threshold level while prioritizing identification of a channel having a lowest estimated probability of being subject to a jamming attack by an entity targeting the first user node. The RL process may thus balance exploration of the action space of available channels with exploiting knowledge based on the estimated probabilities.

Steps that may be performed in order to carry out the identification of a channel at step 420 are illustrated in FIG. 2e. As for FIG. 2d, while FIG. 2e shows steps of the method 200, and the accompanying discussion is presented in the context of those steps being performed by the RAN node, exactly the same steps may be included in the method 400, and performed by the first user node. Reference is therefore made to the description of FIG. 2e for steps that may be carried out by the first user node in identifying a channel predicted to have the greatest TTR with an entity targeting the first user node.

Referring now to FIG. 4b, the first user node may then communicate with the RAN node over the identified channel in step 430.

As discussed above with reference to the method 300, communication signals on the first channel are caused to emulate the communication signals that were exchanged between the RAN node and the first user node over the first channel. In some examples, this may be achieved by the RAN node, and/or by another node, which may for example have been occupying the identified channel. In other examples, this may be achieved by the first user node, and in step 440, the first user node may cause communication signals on the first channel to emulate the communication signals that were exchanged between the RAN node and the first user node over the first channel. As illustrated at 440a, this may be achieved by the first user node by continuing to communicate with the RAN node over the first communication channel, while also communicating with the RAN node over the identified channel. The first user node may for example employ dual mode user plane in order to both communicate with the RAN node over the identified channel and continue to communicate with the RAN node over the first communication channel.

In step 450, the first user node may additionally or alternatively cause communication signals exchanged with the RAN node over the identified channel to differ in an observable characteristic to the signals that were exchanged with the RAN node over the first channel. As illustrated at step 450a, this may comprise causing a distortion signal to be added to a data signal exchanged with the RAN node over the identified channel, wherein an observable characteristic of the combination of the data signal and distortion signal differs from an observable characteristic of the data signal exchanged with the RAN node over the first channel.

As discussed above, the methods 100 and 200 may be performed by a RAN node, and the present disclosure provides a RAN node that is adapted to perform any or all of the steps of the above discussed methods. The RAN node may comprise a physical node such as a computing device, server etc., or may comprise a virtual node. A virtual node may comprise any logical entity, such as a Virtualized Network Function (VNF) which may itself be running in a cloud, edge cloud or fog deployment. The RAN node may be operable to be instantiated in a cloud-based deployment.

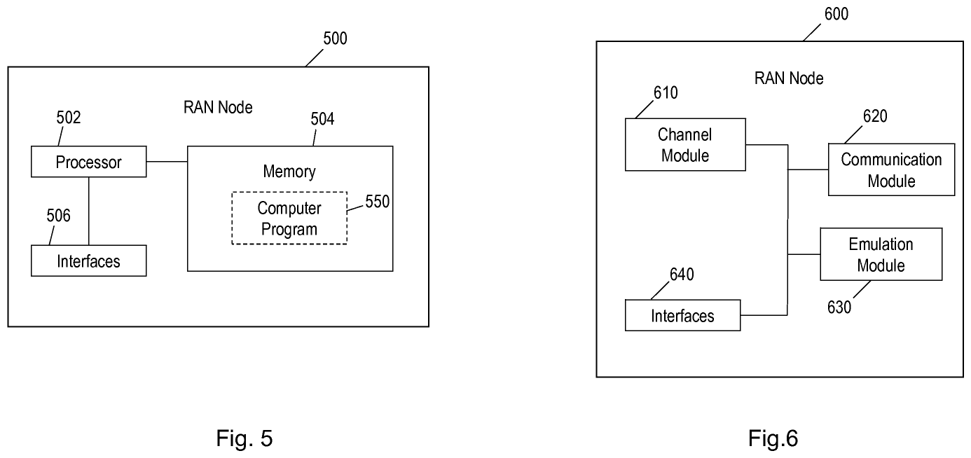

FIG. 5 is a block diagram illustrating an example RAN node 500 which may implement the method 100 and/or 200, as illustrated in FIGS. 1 and 2a to 2e, according to examples of the present disclosure, for example on receipt of suitable instructions from a computer program 550. Referring to FIG. 5 the RAN node 500 comprises a processor or processing circuitry 502, and may comprise a memory 504 and interfaces 506. The processing circuitry 502 is operable to perform some or all of the steps of the method 100 and/or 200 as discussed above with reference to FIGS. 1 and 2a to 2e. The memory 504 may contain instructions executable by the processing circuitry 502 such that the RAN node 500 is operable to perform some or all of the steps of the method 100 and/or 200, as illustrated in FIGS. 1 and 2a to 2e. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive, etc. The interfaces 506 may be operable to facilitate communication with a first user node, and/or with other nodes or modules, over suitable communication channels.

FIG. 6 illustrates functional modules in another example of RAN node 600 which may execute examples of the methods 100 and/or 200 of the present disclosure, for example according to computer readable instructions received from a computer program. It will be understood that the modules illustrated in FIG. 6 are functional modules, and may be realized in any appropriate combination of hardware and/or software. The modules may comprise one or more processors and may be integrated to any degree.

Referring to FIG. 6, the RAN node 600 comprises a channel module 610 for, on detecting that a first channel, over which the RAN node is exchanging communication signals with a first user node, is subject to a jamming attack, identifying, from among channels in the communication network that are not currently occupied by any user node having an assigned priority over a threshold level, the channel that is predicted to have the greatest TTR with an entity targeting the first user node with a jamming attack. The RAN node 600 further comprises a communication module 620 for initiating communication with the first user node over the identified channel, and an emulation module 630 for causing communication signals on the first channel to emulate the communication signals that were exchanged between the RAN node and the first user node over the first channel. The RAN node 600 may further comprise interfaces 640, which may be operable to facilitate communication with a first user node, and/or with other nodes or modules, over suitable communication channels.

As discussed above, the methods 300 and 400 may be performed by a first user node, and the present disclosure provides a first user node that is adapted to perform any or all of the steps of the above discussed methods. The first user node may comprise a physical node such as a computing device, server etc., or may comprise a virtual node. A virtual node may comprise any logical entity, such as a Virtualized Network Function (VNF) which may itself be running in a cloud, edge cloud or fog deployment. The first user node may be operable to be instantiated in a cloud-based deployment. In one for example, the first user node may comprise a UE, terminal device, MTC device, etc.

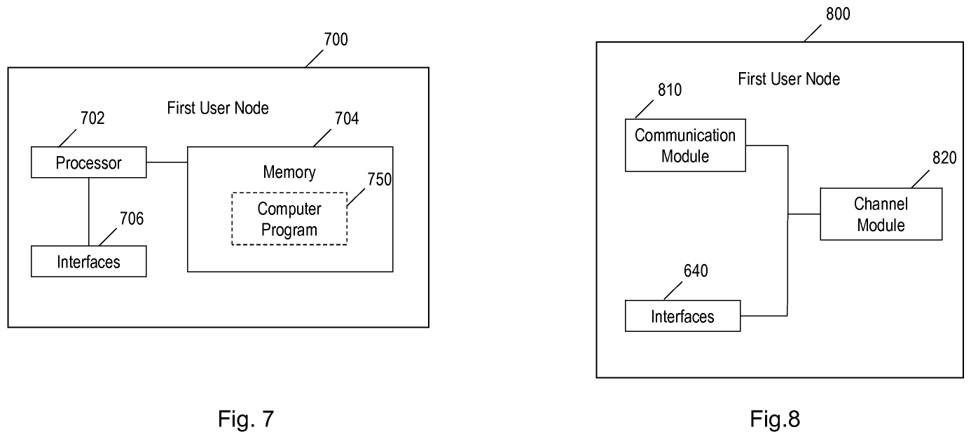

FIG. 7 is a block diagram illustrating an example first user node 700 which may implement the method 300 and/or 400, as illustrated in FIGS. 3, 4a and 4b, according to examples of the present disclosure, for example on receipt of suitable instructions from a computer program 750. Referring to FIG. 7, the first user node 700 comprises a processor or processing circuitry 702, and may comprise a memory 704 and interfaces 706. The processing circuitry 702 is operable to perform some or all of the steps of the method 300 and/or 400 as discussed above with reference to FIGS. 3, 4a and 4b. The memory 704 may contain instructions executable by the processing circuitry 702 such that the first user node 700 is operable to perform some or all of the steps of the method 300 and/or 400, as illustrated in FIGS. 3, 4a and 4b. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive, etc. The interfaces 706 may be operable to facilitate communication with a RAN node, and/or with other nodes or modules, over suitable communication channels.

FIG. 8 illustrates functional modules in another example of first user node 800 which may execute examples of the methods 300 and/or 400 of the present disclosure, for example according to computer readable instructions received from a computer program. It will be understood that the modules illustrated in FIG. 8 are functional modules, and may be realized in any appropriate combination of hardware and/or software. The modules may comprise one or more processors and may be integrated to any degree.

Referring to FIG. 8, the first user node 800 comprises a communication module 810 for, on detecting that a first channel, over which the first user node is exchanging communication signals with a RAN node, is subject to a jamming attack, communicating with the RAN node over an identified channel, wherein the identified channel has been identified, from among channels in the communication network that are not currently occupied by any user node having an assigned priority over a threshold level, as being predicted to have the greatest TTR with an entity targeting the first user node with a jamming attack. The first user node may in some examples comprise a channel module 820 for identifying the channel. Communication signals on the first channel are caused to emulate the communication signals that were exchanged between the RAN node and the first user node over the first channel. The first user node 800 may further comprise interfaces 840, which may be operable to facilitate communication with a RAN node, and/or with other nodes or modules, over suitable communication channels.

FIGS. 1 to 4b discussed above provide an overview of methods which may be performed according to different examples of the present disclosure. These methods may be performed by a RAN node and a first user node respectively, as illustrated in FIGS. 5 to 8. The methods facilitate a robust channel hopping procedure, in which TTR with a jamming entity is maximized, and signal emulation is used to deceive a jammer into remaining on the original channel of communication between the targeted first user node and the RAN node. There now follows a detailed discussion of how different process steps illustrated in FIGS. 1 to 4b and discussed above may be implemented. The functionality and implementation detail described below is discussed with reference to the nodes of FIGS. 5 to 8 performing examples of the methods 100, 200, 300 and/or 400, substantially as described above.

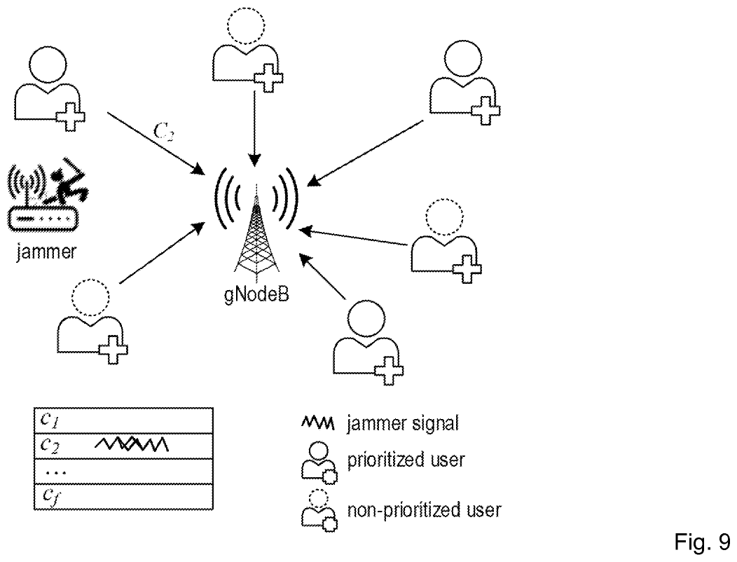

FIG. 9 illustrates a part of a cellular communication network deployed for a specific mission-critical system. For example, it might be deployed to control the neighborhood area of the electrical network (smart grids). The network comprises a RAN node such as a gNodeB, and a set of n legitimate users U={u₁, . . . , uₙ} in the presence of a jammer. The different users are placed one hop away from the gNodeB.

As depicted in FIG. 9, a set C={c₁, . . . , c_{f}} of f channels, i.e., frequency bands, are used to establish communication between the users and the gNodeB. Time is divided into multiple consecutive time slots. We denote as t the time slot starting at time instant t. We use cⁱ(t) to denote the frequency band occupied by user uᵢ during the time slot t.

It is assumed that:
During t, a frequency band may be occupied by a maximum of one user.

∀uᵢ,uⱼ∈U where i≠j,cⁱ(t)≠c^{j}(t).
Each user occupies a maximum of one channel to communicate with the gNodeB.

∀k,h∈{1, . . . , f} where h≠k and cⁱ(t)=cₖ then cⁱ(t)≠cₕ
The gNodeB can communicate simultaneously with f users throughout the set of channels C.

$${β}_{k}^{i}$$

represents the probability that the jammer interested in the traffic of uᵢ attacks the channel cₖ.

$${β}_{k}^{i}$$

is a function of the channel gain between uᵢ and the jammer in cₖ and the power transmission on cₖ by the legitimate user occupying this channel. It is assumed that

$${β}_{k}^{i}$$

is known by the gNodeB and uᵢ.

The users are classified into two sets based on the exchanged traffic: prioritized P* and non-prioritized P. Prioritized users exchange sensitive data, and their traffic belongs to the URLLC class. They have strict delay requirements.

### Data and Signal Models

The data exchanged between uᵢ and gNodeB, and their associated signal distribution, are denoted by by Mᵢ and Sᵢ respectively. It is assumed that the jammer is smart, and can learn information about the data Mᵢ and the distribution Sᵢ. It is also assumed that a user keeps transmitting the same data and signal distributions for a certain period of time.

The mutual information between transmitted data Mᵢ and Mᵢ is denoted by I(Mᵢ, Mᵢ). I(Mᵢ, Mⱼ)∈[0, 1] is a measure of the quantity of information that is shared between both Mᵢ and Mⱼ. The closer the value of I(Mᵢ, Mᵢ) to 1, the more highly correlated are Mᵢ and Mⱼ. The mutual information between the signals generated by two users uᵢ and uⱼ I(Sᵢ, Sⱼ)∈[0, 1] is used to quantify similarity between the two signal distributions.

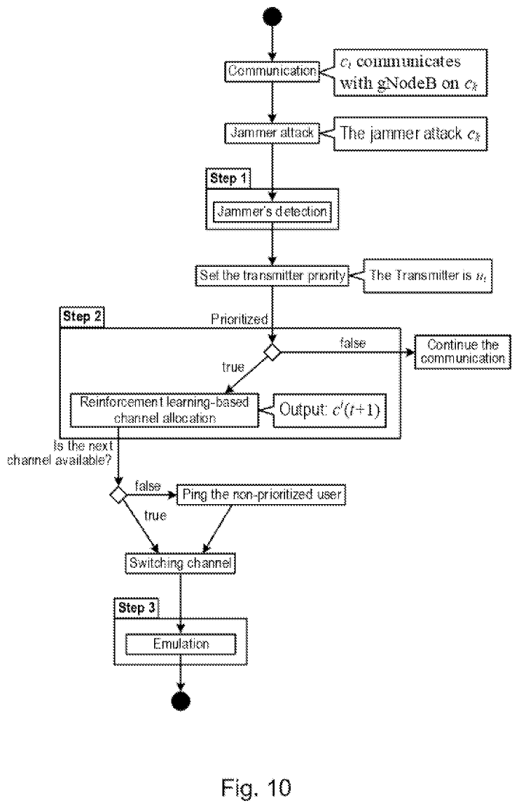

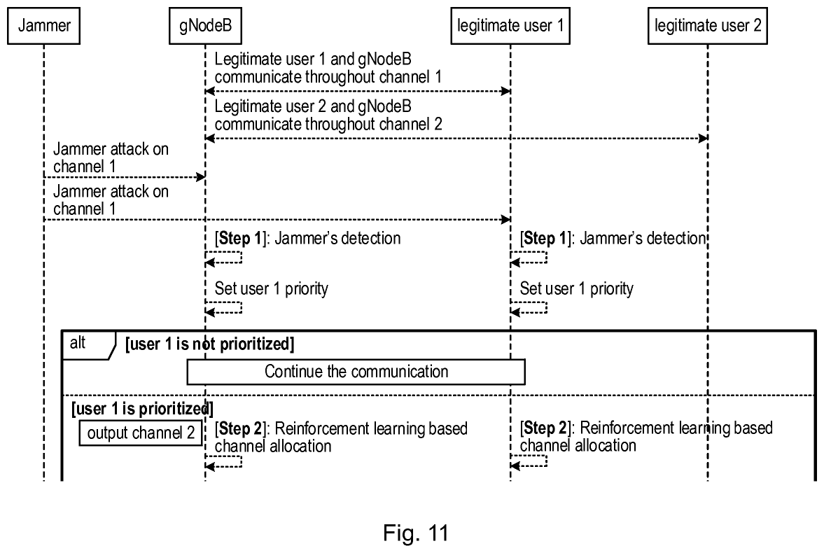

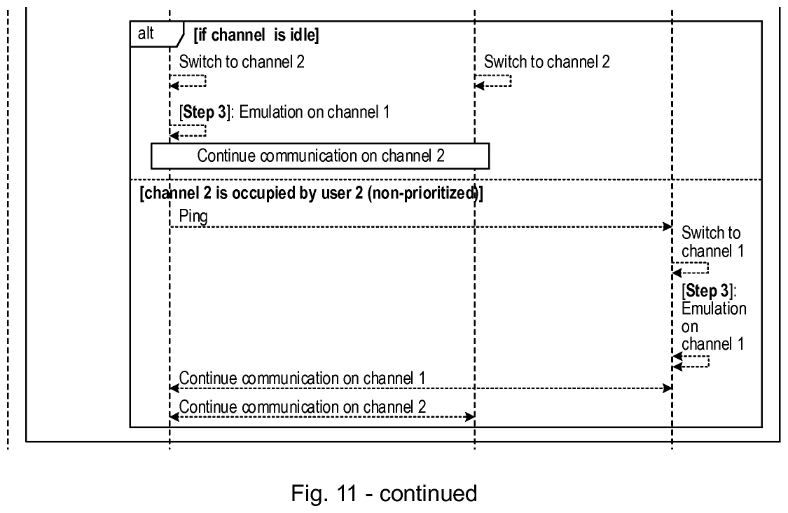

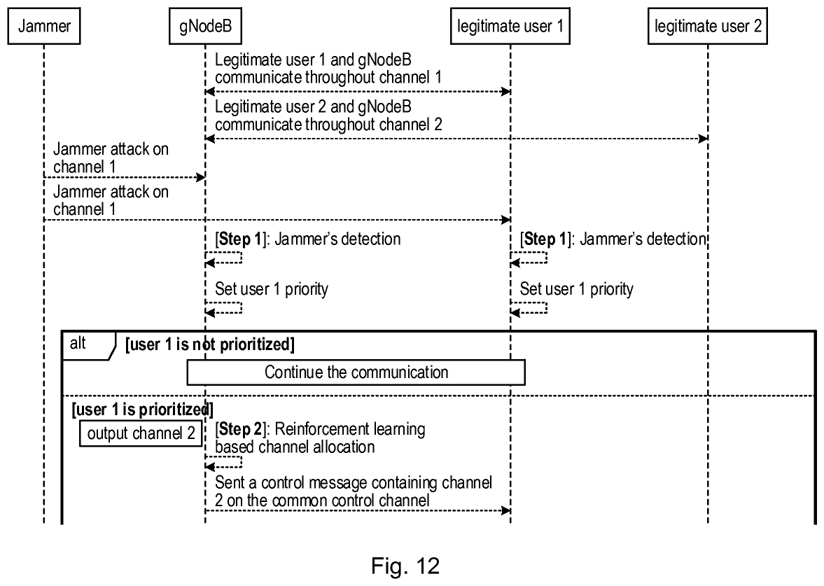

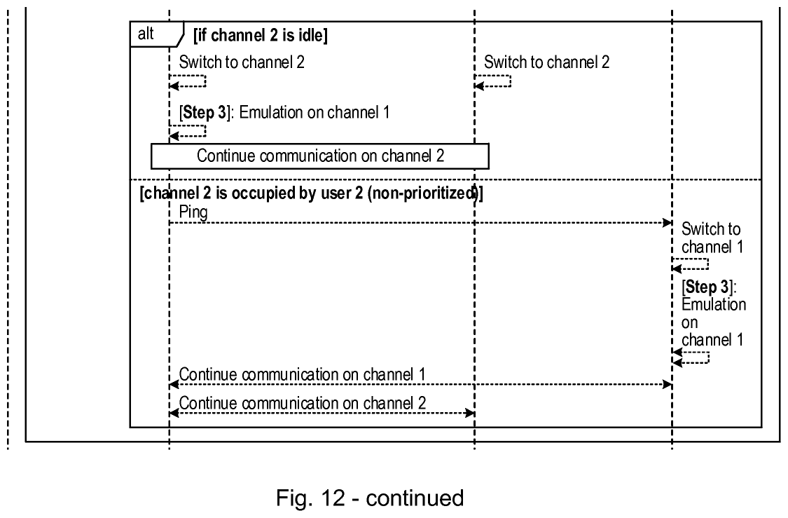

FIG. 10 is a flow chart illustrating a process flow that may be used to implement examples of the methods 100, 200 described above in the context of the above described network. FIGS. 11 and 12 are sequence diagrams showing messages exchanges and processing steps carried out in order to implement the process flow of FIG. 10. FIG. 11 illustrates an example in which both the RAN node (gNodeB) and first user node (legitimate user 1) identify the channel to which they should switch communication. FIG. 12 illustrates an example in which only the RAN node (gNodeB) identifies the new channel, and the RAN node communicates this information to the first user node.

It is assumed that the jammer is interested in the prioritized user uᵢ∈P*. At time t, uᵢ communicating with gNodeB throughout cₖ and transmitting prioritized traffic. The jammer is emitting noise on cₖ to disturb the communication between uᵢ and the gNodeB.

FIGS. 10 to 12 illustrate implementation of the methods 200 and 400 divided into three main phases, or steps:
1) Phase 1 (Jammer Detection): How this phase is performed is outside the scope of the present methods. It is assumed that uᵢ and gNodeB use existing jammer detection solutions to reveal the presence of the jammer, detecting that noise present on the channel they are using is a jamming signal.

Once the jammer is detected, if the user is not prioritized then it continues its communication over the current channel, or stops communication until the channel becomes secure. If the user is prioritized, as is the case for uᵢ, then uᵢ and the gNodeB (or just the gNodeB as in FIG. 12) run the reinforcement learning-based channel identification phase (phase 2).
2) Phase 2 (Reinforcement Learning-based channel identification—steps 120, 220, 320, 420 of methods 100 to 400): The legitimate user uᵢ is prioritized (uᵢ E P*), the reinforcement learning-based channel selection is carried out. This process, discussed in detail the following section, outputs the channel cⁱ(t+1). During t+1, uᵢ and the gNodeB switch to cⁱ(t+1) to continue their communication. cⁱ(t+1) is the channel that maximizes the TTR between the jammer and uᵢ. uᵢ and gNodeB use reinforcement learning to select a channel which is not occupied by a prioritized user.

After identifying the channel, uᵢ and gNodeB switch to cⁱ(t+1). Phase 3 is then carried out, either by the gNodeB, uᵢ, or by a non-prioritized user who was occupying the identified channel. The selected channel (cⁱ(t+1)) state (Idle or occupied by a prioritized user), will determine how phase 3 is carried out.
3) Phase 3 (Emulation—steps 140, 240, 340, 440 of methods 100 to 400): If cⁱ(t+1) is occupied by a non-prioritized user, then this user switches to the attacked channel cₖ, continues its communication with gNodeB and runs the Emulation process described below. If cⁱ(t+1) is Idle, then the gNodeB runs the Emulation, it uses one of its antennas to send messages to deceive the jammer. In this event, the uᵢ may also assist by continuing to transmit on the attacked channel, for example using dual user plane mode. uᵢ may additionally cause the signal it sends on the new channel to differ in appearance from its original signal, so as not to alert the jammer to the possibility of communication having been continued on the new channel.
   Reinforcement Learning Based Channel Selection Solution (Steps 120, 220a-220d, 221a-221c, 222-226, 320, 420 of Methods 100, 200, 300, 400)

Reinforcement learning is the area of machine learning that enables an agent to learn in an interactive environment by trial and error using feedback from its own actions, experiences, and interactions with its surrounding environment. Reinforcement learning is widely recognized for decision making in dynamic environment since the agent is in continuous discovering of the system state.

The channel hopping process and the channel selection according to examples of the present disclosure can modeled as a multi-armed bandit problem. The problem is characterized by an agent (the emitter and/or the receiver) which is choosing actions (identifying a new channel), and each action has a reward that is returned according to a given, underlying probability distribution. In the present context, each channel is represented by an armed bandit. The objective is to select the channel that maximizes the legitimate prioritized user reward.

During time slot t having a duration τ, it is assumed that a channel cₖ is occupied by uⱼ. The jammer wants to attack uⱼ. The probability that the jammer sends noise on cₖ is:

$${P}_{k} ( t ) = I ( {S}_{i} , {S}_{j} ) I ( {M}_{i} , {M}_{j} ) {β}_{k}^{j}$$

Pₖ(t) is dependent on the similarities between the uⱼ and the uᵢ data and signal, I(Sᵢ, Sⱼ) and I(Mᵢ, Mᵢ), respectively. The probability is also a function of the jammer gain on cₖ, i.e.,

$${β}_{k}^{j} .$$

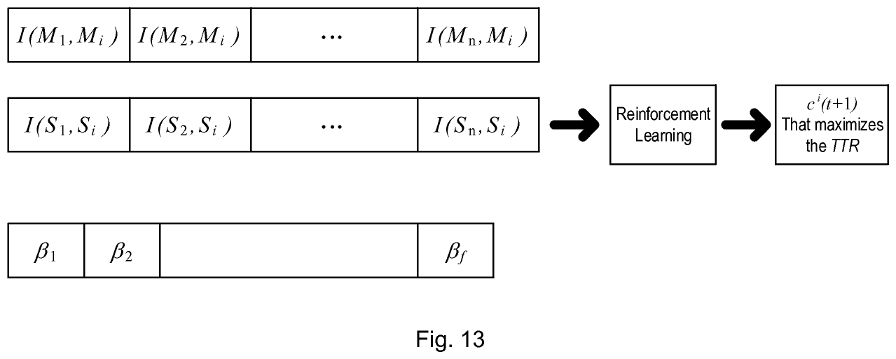

The objective, as illustrated in FIG. 13, is to enable u; and gNodeB to select the channel which will be free of jammers for the longest time, i.e., the channel with the minimum probability of being selected by the jammer. The value of action cⁱ(t) at time slot ‘t’, Qₜ(cⁱ(t)) is therefore formulated as:

$${Q}_{t} ( {c}^{i} ( t ) ) = ( 1 - {P}_{k} ( t ) ) * τ$$

where cⁱ(t)=cₖ and (1−Pₖ(t)) is the probability that the jammer will not select cₖ. The Upper Confidence Bound (UCB) Algorithm can be used to select the channels. During the T time slots, the channel for each slot is identified as:

$${c}^{i} ( t ) = arg {max}_{{c}_{k}} [ {Q}_{t} ( {c}_{k} ) + c \sqrt{\frac{log t}{{N}_{t} ( {c}_{k} )}} ]$$

where Nₜ(cₖ): is the number of times that channel cₖ has been selected, prior to time t
   c is a confidence value that controls the level of exploration.
      Machine Learning Based Emulation Mechanism (Steps 140, 240a-240c, 241-243, 340, 440 of Methods 100, 200, 300, 400)

How the emulation process is conducted, and by which entity it is carried out, is dependent on the new channel's state: occupied by a non-prioritized user (uⱼ) or Idle. If occupied by uⱼ, then this latter will switch to the jammed channel cₖ and continue the communication with the gNodeB while emulating the prioritized node's (uᵢ) signal. If the selected channel is Idle, then the gNodeB will execute the emulation process, and may request uᵢ to continue sending communication on the jammed channel, for example in dual mode user plane.

The purpose of the emulation process is to deceive the jammer. The jammer will continue receiving the same signal as if the legitimate user was still sending it, while the legitimate user is changed to another channel. The moderator of this emulation may be the gNodeB or the non-prioritized user based on the new selected channel state.

Examples of the present disclosure propose a machine learning solution to move from one signal to another, using a concept employed in image-to-image translation problems which map an image in one domain to a corresponding image in another domain (e.g., transforming a simple selfie to a cartoon image or vice versa). From a probabilistic modeling perspective, the key challenge of image-to-image translation is to learn a joint distribution of images in different domains. In the context of the present disclosure, the challenge is to learn a joint distribution of signals per channel. According to coupling theory, there exists an infinite set that can arrive at the given marginal distributions in general. A shared-latent space assumption is made to overcome this problem. It assumes a pair of corresponding signals in different domains can be mapped to a same latent representation in a shared-latent space.

Let X₁ and X₂ be two signals domain (respectively coming from user 1 and user 2). Given any samples drawn from the two marginal distributions P_{X}_{₁}(x₁) and P_{X}_{₂}(x₂), it is possible to learn a shared latent space z that allows to recover both samples. That is to say there exist functions F₁, F₂ and G₁, G₂ such that for every given pair of corresponding signals (x₁, x₂), z=F₁(x₁)=F₂(x₂) and also x₁=G₁(z) and X₂=G₂(z). In the language of the methods 200, 400, F₁, F₂ are the first and second encoder ML models respectively, and G₁, G₂ are the second and first decoder ML models respectively.

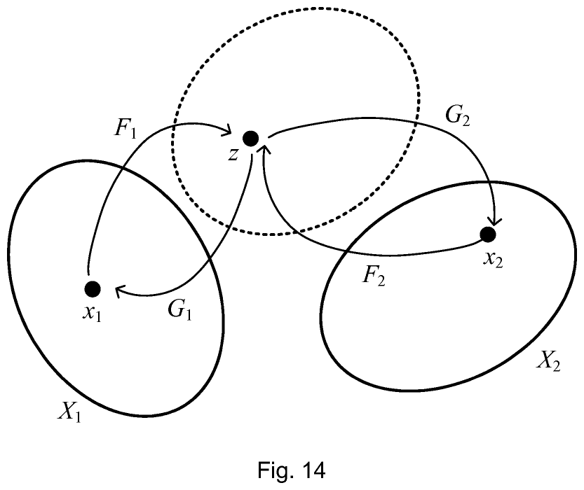

Signal to signal translation according to examples of the present disclosure is illustrated in FIG. 14. To emulate one signal coming from X₁ to a signal from X₂ the function T can be computer as a translator, where T_{1→2}=G₂(F₁(x₁)). Similarly, the inverse translation converting any signal from X₂ to X₁ can be computed from the function T_{2→1}=G₁(F₂(x₂)).

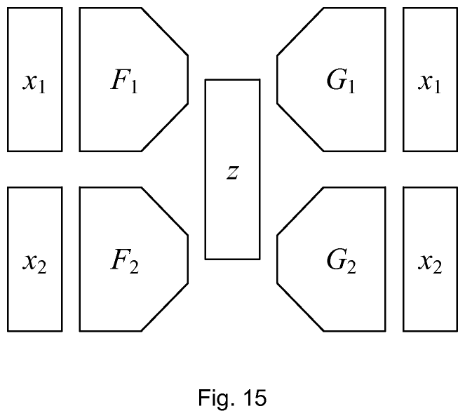

Practically such functions can be learned using machine learning algorithms that enable learning of a latent space, including autoencoders, variational autoencoders, GANs, etc. FIG. 15 illustrates a neural network architecture for the signal-to-signal translation involving F₁, F₂ and G₁, G₂.

In some examples, the training of the signal-to-signal models (step 205 of method 200) may be conducted offline. Then the models will be uploaded to the gNodeB, which will send the relevant encoder and decoder ML models to each node involved in the emulation process (e.g., non-prioritized nodes). The model may be updated frequently, and in some examples, this may be performed online, or offline at a defined time. The translation models may be updated when a data shift is detected, that is when a difference is observed between the distributions of the signals at the time of training and the time of inference. One way of aligning the distributions is by minimizing the distance between domains. The most commonly used distance measures in domain adaptation are maximum mean discrepancy (MMD), Wasserstein metric, correlation alignment (CORAL), Kullback-Leibler (KL) divergence, and contrastive domain discrepancy (CDD).

Following attack detection and identification of a new channel, if a non-prioritized user is to perform the emulation on the attacked channel, then before sending any information to the user, the gNodeB, it may send the encoder ML model and decoder ML model that allow translation of the non-prioritized user's signal to emulate the prioritized, attacked user's signal: the first encoder ML model F₁ and first decoder ML model G₂.

In some examples, in which the jamming attack detection is based on generative models, the time taken to train the signal-to-signal translation may be reduced using Transfer Learning. Transfer learning can be used to transfer knowledge from the machine learning attack detection model to the signal-to-signal translation model. Transfer learning between the jamming detection and signal translation models can reduce the training time and enhance the performance of signal-to-signal translation as it will be enriched by the new knowledge.

### Deployment Scenarios

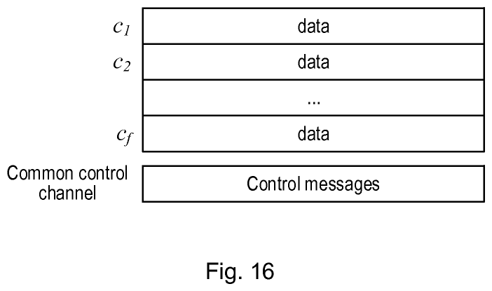

The methods disclosed herein can be deployed in a range of use cases, involving for example MBB and URLLC communication. In one example deployment option, the RAN node (gNodeB in the described example) may be responsible for the signal emulation and channel decision process. According to this option, it may be assumed that the legitimate users and the gNodeB have a common control channel to exchange control messages, as illustrated in FIG. 16. The gNodeB can use this control channel to inform the attacked user of his next selected channel to switch and continue the communication. This reflects the signalling sequence of FIG. 12. In another example deployment option, both the gNodeB and the legitimate attacked user may execute the channel decision process. According to this option, as discussed above, the gNodeB and the legitimate user have information about the signal and exchanged data similarities, and so are able to perform the process of identifying the channel with the longest TTR with the jammer. Each of the gNodeB and the attacked user perform channel identification and then they switch to the identified channel to continue communication. According to both of the above deployment options, signal emulation may be performed by the gNodeB, a non-prioritized user occupying the identified channel, and/or the attacked legitimate user, depending on the state of the identified channel and the direction of communication.

Examples of the present disclosure thus provide an anti-jamming solution which, while having a broad relevance to a range of communication situations, may have particular advantages for URLLC and other mission-critical network applications.

Example methods according to the present disclosure involve the identification of a new channel for communication with a targeted user node, and emulation of the original signals exchanged with the first user node, for the purpose of jammer deception. As discussed above, existing studies for channel hopping select the next visited channel based on the jammers' channel gain, as such studies mainly assume that jammers search for signals with high power transmission. In addition, existing methods seek to minimize the TTR between the legitimate sender and the legitimate receiver. In contrast to these existing methods, examples according to the present disclosure propose a channel selection strategy based on reinforcement learning that focuses on how to maximize the time required by a jammer to find the new channel selected by the legitimate sender and receiver. Example methods disclosed herein thus take account of the ability of the jammer to learn about the legitimate users' signal and data structure, and exploit this ability, and the jammer's frequency band gain, to identify the channel that maximizes TTR with the jammer. In some examples, the methods seek to maximize the number of busy channels having approximate traffic characteristics consistent with those of the attacked user. Consequently, the time a jammer spends visiting different channels before identifying the newly selected channel is also maximized.

Existing anti-jamming methods seek to deceive the jammers by emitting arbitrary signals on a victim channel. Such methods must therefore first select this new victim channel, and then design the fake signal based on the jammers' channel gain, with the intention of encouraging the jammer to switch to this new victim channel. In contrast, examples of the present disclosure use the initially jammed channel as the victim channel, deceiving the jammers by keeping them attracted to the same frequency band. A machine learning solution may be used to emulate the original targeted signal using traffic generated by legitimate users exchanging non-prioritized traffic.

Example methods according to the present disclosure thus protect sensitive data, for example in mission-critical networks, from being intercepted by jammers, preserving reliability and latency requirements for the data. Thanks to the emulation of the signal on the originally attached channel, revealing that the transmitted signal is not the original attacked one is a challenging task for jammers. Jammers are therefore likely to remain on the originally attacked channel, unaware that the legitimate user has switched to communicate on a new secure channel.

Example methods of the present disclosure exploit different metrics that jammers can learn over time to reveal information about the behavior of legitimate users, the transmitted data, and the signal structures. Example methods disclosed herein therefore offer a robust anti-jamming solution which, while offering particular advantages for mission-critical networks, can also be extended to cover every type of network.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1. A method performed by a Radio Access Network (RAN) node in a communication network, the method comprising:
on detecting that a first channel, over which the RAN node is exchanging communication signals with a first user node, is subject to a jamming attack:
identifying, from among channels in the communication network that are not currently occupied by any user node having an assigned priority over a threshold level, the channel that is predicted to have the greatest Time To Rendezvous (TTR) with an entity targeting the first user node with the jamming attack;
initiating communication with the first user node over the identified channel; and
causing communication signals on the first channel to emulate the communication signals that were exchanged between the RAN node and the first user node over the first channel.

2. The method as claimed in claim 1, wherein identifying, from among channels in the communication network that are not currently occupied by any user node having an assigned priority over a threshold level, the channel that is predicted to have the greatest TTR with an entity targeting the first user node with a jamming attack comprises using a Reinforcement Learning process to identify the channel.

3. The method as claimed in claim 1, wherein identifying, from among channels in the communication network that are not currently occupied by any user node having a priority over a threshold level, the channel that has the lowest probability of being subject to a jamming attack by an entity targeting the first user node comprises:
using the Upper Confidence Bound (UCB) algorithm to identify the channel, wherein channel value comprises a function of similarity between at least one of:
data exchanged between the RAN node and the first user node, and data exchanged between the RAN node and a user node occupying the channel; and
signal distributions of the data exchanged between the RAN node and the first user node, and the data exchanged between the RAN node and a user node occupying the channel.

4. The method as claimed in claim 1, wherein identifying, from among channels in the communication network that are not currently occupied by any user node having an assigned priority over a threshold level, the channel that is predicted to have the greatest TTR with an entity targeting the first user node with a jamming attack comprises:
for channels in the communication network, estimating a probability of being subject to a jamming attack by an entity targeting the first user node.

5. The method as claimed in claim 4, wherein estimating a probability of a channel being subject to a jamming attack by an entity targeting the first user node comprises calculating the estimated probability as a function of:
a similarity measure between data exchanged between the RAN node and the first user node, and data exchanged between the RAN node and a user node occupying the channel; and
a similarity measure between the signal distributions of the data exchanged between the RAN node and the first user node, and the data exchanged between the RAN node and a user node occupying the channel.

6. The method as claimed in claim 5, wherein the similarity measure comprises Mutual Information (MI).

7. The method as claimed in claim 5, wherein estimating a probability of a channel being subject to a jamming attack by an entity targeting the first user node comprises calculating the estimated probability as a function also of a jamming gain parameter for the channel, wherein the jamming gain parameter for the channel is a function of:
the channel gain between the user node occupying the channel and the jamming entity in the channel; and
the power transmission on the channel by the user node occupying the channel.

8. The method as claimed in claim 4, wherein estimating a probability of a channel being subject to a jamming attack by an entity targeting the first user node comprises calculating the estimated probability as the product of:
MI between data exchanged between the RAN node and the first user node, and data exchanged between the RAN node and a user node occupying the channel;
MI between the signal distributions of the data exchanged between the RAN node and the first user node, and the data exchanged between the RAN node and a user node occupying the channel; and
a jamming gain parameter for the channel, wherein the jamming gain parameter for the channel is a function of:
the channel gain between the user node occupying the channel and the jamming entity in the channel; and
the power transmission on the channel by the user node occupying the channel.

9. The method as claimed in claim 1, wherein identifying, from among channels in the communication network that are not currently occupied by any user node having an assigned priority over a threshold level, the channel that is predicted to have the greatest TTR with an entity targeting the first user node with a jamming attack comprises:
using a Reinforcement Learning process to explore an action space of channels in the communication network that are not currently occupied by any user node having an assigned priority over a threshold level while prioritizing identification of a channel having a lowest estimated probability of being subject to a jamming attack by an entity targeting the first user node.

10. The method as claimed in claim 1, wherein identifying, from among channels in the communication network that are not currently occupied by any user node having an assigned priority over a threshold level, the channel that is predicted to have the greatest TTR with an entity targeting the first user node with a jamming attack comprises:
identifying a candidate set of channels that are not currently occupied by any user having an assigned priority above the threshold level;
for channels in the candidate set:
calculating a value of each channel during a respective time slot as a function of an estimated probability that the channel will not be subject to a jamming attack by an entity targeting the first user node;
calculating a measure of uncertainty in the calculated channel value; and
calculating a channel score as a sum of the channel value and channel value uncertainty; and
selecting as the identified channel, the channel having the highest channel score.

11. The method as claimed in claim 10, wherein the value of a channel increases as the estimated probability that it will not be subject to a jamming attack by an entity targeting the first user node increases.

12. The method as claimed in claim 10, wherein the probability that the channel will not be subject to a jamming attack by an entity targeting the first user node comprises the complement of the probability that the channel will be subject to a jamming attack by an entity targeting the first user node.

13.-19. (canceled)

20. The method as claimed in claim 1, wherein causing communication signals on the first channel to emulate the communication signals that were exchanged between the RAN node and the first user node over the first channel comprises:
Causing a signal emulation process to be carried out on a first signal for exchange over the first channel, wherein the signal emulation process causes an observable characteristic of the first signal to resemble an observable characteristic of the communication signals that were exchanged between the RAN node and the first user node over the first channel.

21.-22. (canceled)

23. The method as claimed in claim 20, wherein the first signal comprises at least one of:
a signal for exchange with a user node that was occupying the identified channel; or
a victim signal for the purpose of deceiving the entity targeting the first node.

24. The method as claimed in claim 23, wherein the first signal comprises a signal for exchange with a user node that was occupying the identified channel, and wherein the method further comprises:
receiving the recovered signal on the first channel;
using a second encoder ML model to generate a representation of the recovered signal; and
using a second decoder ML model to recover the first signal from the generated representation.

25. The method as claimed in claim 24, wherein the first encoder ML model and second encoder ML model are each configured to generate a representation in the same first latent space, and wherein the first decoder ML model and second decoder ML model are each configured to recover a signal from the same first latent space.

26.-31. (canceled)

32. A method performed by a first user node in a communication network, the method comprising:
on detecting that a first channel, over which the first user node is exchanging communication signals with a Radio Access Network, RAN, node, is subject to a jamming attack:
communicating with the RAN node over an identified channel, wherein the identified channel has been identified, from among channels in the communication network that are not currently occupied by any user node having an assigned priority over a threshold level, as being predicted to have the greatest Time To Rendezvous (TTR) with an entity targeting the first user node with a jamming attack;
wherein communication signals on the first channel are caused to emulate the communication signals that were exchanged between the RAN node and the first user node over the first channel.

33.-54. (canceled)

55. A computer program product comprising a non-transitory computer readable medium, the computer readable medium having computer readable code embodied therein, the computer readable code being configured such that, on execution by processing circuitry, the processing circuitry is caused to perform a method as claimed in claim 1.

56. A Radio Access Network (RAN) node in a communication network, the RAN node comprising processing circuitry configured to cause the RAN node to:
on detecting that a first channel, over which the RAN node is exchanging communication signals with a first user node, is subject to a jamming attack:
identify, from among channels in the communication network that are not currently occupied by any user node having an assigned priority over a threshold level, the channel that is predicted to have the greatest Time To Rendezvous (TTR) with an entity targeting the first user node with a jamming attack;
initiate communication with the first user node over the identified channel; and
cause communication signals on the first channel to emulate the communication signals that were exchanged between the RAN node and the first user node over the first channel.

57. (canceled)

58. A first user node in a communication network, the first user node comprising processing circuitry configured to cause the first user node to:
on detecting that a first channel, over which the first user node is exchanging communication signals with a Radio Access Network (RAN) node, is subject to a jamming attack:
communicate with the RAN node over an identified channel, wherein the identified channel has been identified, from among channels in the communication network that are not currently occupied by any user node having an assigned priority over a threshold level, as being predicted to have the greatest Time To Rendezvous (TTR) with an entity targeting the first user node with a jamming attack;
wherein communication signals on the first channel are caused to emulate the communication signals that were exchanged between the RAN node and the first user node over the first channel.

59. (canceled)
